(19) United States
(12) Patent Application Publication
(10) Pub. No.: US 2023/0199439 A1
(43) Pub. Date: Jun. 22, 2023

(54) MULTICAST AND BROADCAST SERVICE SESSION RECEPTION MODE SWITCHING IN WIRELESS COMMUNICATION NETWORKS

(71) Applicant: ZTE Corporation, Shenzhen (CN)

(72) Inventors: Zijiang MA, Shenzhen (CN); Yin GAO, Shenzhen (CN)

(21) Appl. No.: 18/170,376

(22) Filed: Feb. 16, 2023

Related U.S. Application Data
(63) Continuation of application No. PCT/CN2020/134383, filed on Dec. 8, 2020.

(51) Int. Cl. H04W 4/06; H04W 28/02

(52) U.S. Cl. CPC H04W 4/06; H04W 28/0263; H04W 28/0268

(57) ABSTRACT

Methods and systems for establishing a multicast broadcast service session and switching between a point-to-point mode and a point-to-multipoint mode during the multicast broadcast service session are described. In one example aspect, the method includes configuring a first mapping between a dedicated radio bearer and a protocol data unit session to enable data communication in a point-to-point mode, configuring a second mapping between a multicast broadcast service radio bearer and a multicast broadcast service session to enable data communication in a point-to-multipoint mode, and providing user data to a mobile device using a combination of the point-to-point mode and/or the point-to-multipoint mode. The first mapping includes a QoS flow mapped to the dedicated radio bearer and the second mapping includes a QoS flow mapped to the multicast broadcast service radio bearer, and the QoS flow of the first mapping is identical to the QoS flow of the second mapping.

### CROSS REFERENCE TO RELATED APPLICATIONS

This patent document is a continuation of and claims benefit of priority to International Patent Application No. PCT/CN2020/134383, filed on Dec. 8, 2020. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for establishing a multicast broadcast service session and switching between a point-to-point mode and a point-to-multipoint mode during the multicast broadcast service session.

In one aspect, a method of data communication is disclosed. The method includes configuring, by a network node, a first mapping between a dedicated radio bearer and a protocol data unit session for a mobile device, wherein the first mapping enables data communication with the mobile device in a point-to-point mode, configuring, by the network node, a second mapping between a multicast broadcast service radio bearer and a multicast broadcast service session for one or more mobile devices including the mobile device, wherein the second mapping enables data communication with the mobile device in a point-to-multipoint mode, and providing user data to the mobile device using a combination of the point-to-point mode and/or the point-to-multipoint mode. The first mapping includes a quality of service (QoS) flow mapped to the dedicated radio bearer and the second mapping includes a quality of service (QoS) flow mapped to the multicast broadcast service radio bearer, and the QoS flow of the first mapping is identical to the QoS flow of the second mapping.

In another aspect, a method of data communication is disclosed. The method includes configuring, by a network node, a first mapping between a dedicated radio bearer and a protocol data unit session for a mobile device, wherein the first mapping enables data communication with the mobile device in a point-to-point mode, determining, by the network node, whether mobile devices in a network satisfy a predetermined condition that requires configuring a multicast broadcast radio bearer to be shared by the mobile devices in a point-to-multipoint mode, configuring, by the network node, a second mapping between a multicast broadcast radio bearer and a multicast broadcast service session for one or more mobile devices including the mobile device upon determination that the mobile devices in a network satisfy the predetermined condition, wherein the second mapping enables data communication with the mobile device in a point-to-multipoint mode, and providing user data to the mobile device using a combination of the point-to-point mode and/or the point-to-multipoint mode.

In another aspect, a method of data communication is disclosed. The method includes receiving, by a mobile device, from a network node, user data associated with a multicast broadcast service session using at least one of a point-to-multipoint communication or a point-to-point communication, and transmitting, by the mobile device, a notification to the network node of whether a signal reception through the point-to-multipoint communication satisfies a predetermined condition.

In another aspect, a method of data communication is disclosed. The method includes receiving, by a mobile device, from a network node, user data associated with a multicast broadcast service session using a point-to-point communication, transmitting, by the mobile device, a notification to the network node that a signal reception through the point-to-multipoint communication satisfies a predetermined condition, and receiving the user data associated with the multicast broadcast service session using a point-to-multipoint communication.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF DRAWINGS

FIG. 1 depicts an architecture for a 5G system based on some example embodiments of the disclosed technology.

FIG. 2 depicts an enhanced 5G system architecture to provide broadcast/multicast services to a user equipment based on some example embodiments of the disclosed technology.

FIG. 3 depicts an example of multicast/broadcast service (MBS) session configuration at an interface between network nodes.

FIG. 4 depicts an example of MBS user data transmission at NG interface based on some implementations of the disclosed technology.

FIG. 5 depicts an example of radio bearer configuration at NG-RAN (next-generation radio access network) based on some implementations of the disclosed technology.

FIG. 6 depicts an example of a dedicated radio resource (DRB) configured without configuring multicast/broadcast service radio bearer (MRB) based on some implementations of the disclosed technology.

FIG. 7 depicts an example of a dedicated radio resource (DRB) configured for some of mobile devices (e.g., UEs) in the network based on some implementations of the disclosed technology.

FIG. 8 depicts an example of a process for wireless communication based on some example embodiments of the disclosed technology.

FIG. 9 depicts another example of a process for wireless communication based on some example embodiments of the disclosed technology.

FIG. 10 depicts another example of a process for wireless communication based on some example embodiments of the disclosed technology.

FIG. 11 depicts another example of a process for wireless communication based on some example embodiments of the disclosed technology.

FIG. 12 depicts a wireless communication system based on some example embodiments of the disclosed technology.

FIG. 13 depicts a block diagram of a portion of a radio system based on some example embodiments of the disclosed technology.

### DETAILED DESCRIPTION

Certain features are described using the example of Fifth Generation (5G) wireless protocol. However, applicability of the disclosed techniques is not limited to only 5G wireless systems.

5G systems (5GS) include multicast/broadcast services. An aspect of these services is multi-cast discovery and the starting and ending of multicast services. User equipment (UEs) may simultaneously operate using unicast (also referred to as unicast) and multicast services. When a UE moves from one radio access network (RAN) node to another RAN node, service continuity of the broadcast and multicast services is needed. Disclosed herein are techniques for providing continuity of service for broadcast and multicast services.

In some example embodiments, a multicast service is a communications service in which the same service and the same content data are provided simultaneously to a set of authorized UEs (i.e., not all UEs in the multicast coverage are authorized to receive the data). A broadcast service is a communications service in which the same service and the same content data are provided simultaneously to all UEs in a geographical area (i.e., all UEs in the broadcast coverage area are authorized to receive the data).

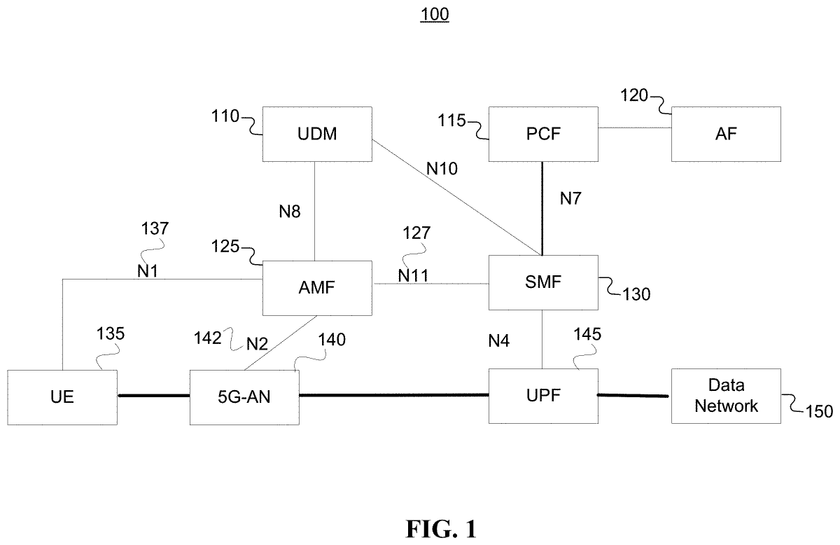

FIG. 1 depicts an example architecture 100 for a 5G system. The 5G System architecture consists of the network functions (NF) as well as other functions described below.

The access and mobility management function (AMF) 125 performs functions including UE mobility management, reachability management, connection management, and other functions. The AMF terminates the radio access network control plane (RAN CP) interface (also referred to as N2 interface 142) and non-access stratum (NAS) (also referred to as N1 interface 137), NAS ciphering and integrity protection. The AMF also distributes the session management (SM) NAS to the proper session management functions (SMFs) via the N11 interface 127.

The session management function (SMF) 130 includes user equipment (UE) internet protocol (IP) address allocation and management, selection and control of an UP function, PDU connection management, etc.

The user plane function (UPF) 145 is an anchor point for intra-/inter-radio access technology (RAT) mobility and the external protocol data unit (PDU) session point of interconnect to a data network. The UPF also routes and forwards data packets as indicated by the SMF, and the UPF buffers the downlink (DL) data when the UE is in idle mode.

The unified data management (UDM) 110 manages the subscription profiles for the UEs. The subscription includes the data used for mobility management (e.g., restricted area), session management (e.g., quality of service (QoS) profile per slice per data network name (DNN)). The subscription data also includes slice selection parameters which are used by the AMF to select an SMF. The AMF and SMF get the subscription from the UDM and the subscription data is stored in the unified data repository (UDR). The UDM uses the data upon receipt of a request from the AMF or SMF.

The policy control function (PCF) 115 governs network behavior based on the subscription and indication from the application function (AF) 120. The PCF provides policy rules to be enforced by the control plane (CP) functions such as the AMF and/or SMF. The PCF accesses the UDR to retrieve policy data.

A network exposure function (NEF) (not shown) may be included in the system for exchanging information between a core network (5GC) and an external third party. For example, the AF 120 may store the application information in the UDR via the NEF.

Multicast broadcast multimedia service (MBMS) was developed for video broadcasting and streaming services. Since its initial development, the MBMS system has been updated to support new services such as public safety, consumer internet of things (CIoT) and vehicle to everything (V2X). With the development and maturity of 5GS, 5GS is may provide multicast-broadcast services for vertical businesses.

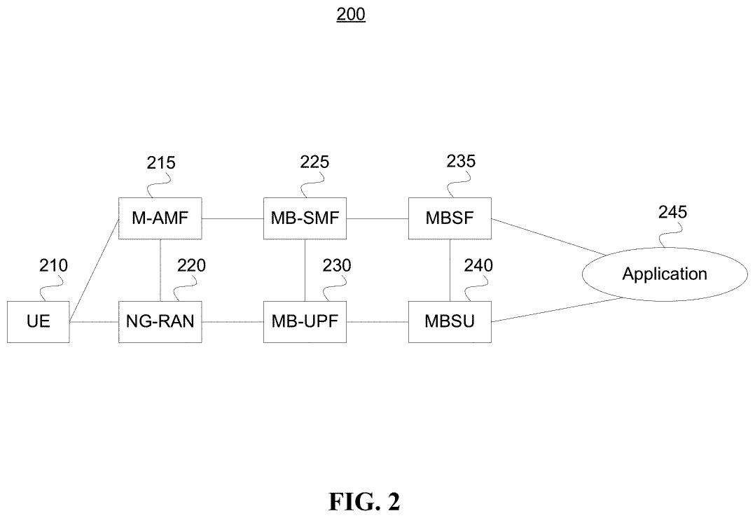

FIG. 2 depicts an example of an enhanced 5G system architecture 200 to provide broadcast/multicast services to a user equipment 230.

The multicast/broadcast service function (MBSF) 235 is a network function (NF) to handle a signaling part of a service layer capability and provides an interface to application server 245. It may be a standalone entity or collocated with an MB-SMF.

The multicast/broadcast service user plane (MBSU) 240 handles a payload part of the service layer capability and may be a standalone entity or collocated with the MBSF or MB-UPF.

The SMF and UPF may be enhanced to support the multicast/broadcast service. The AMF may also be enhanced to make transparent the signaling for multicast/broadcast service between the RAN/UE and multicast/broadcast-SMF (MB-SMF) 225.

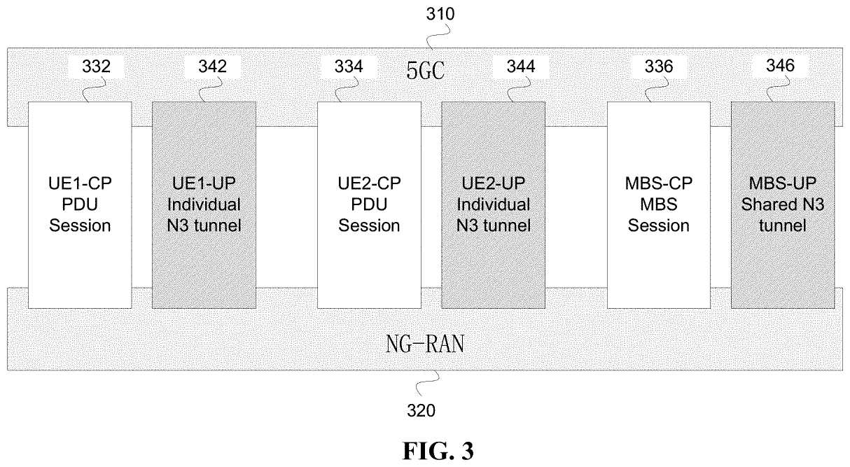

FIG. 3 depicts an example of multicast/broadcast service (MBS) session configuration at an interface between network nodes such as NG interface (e.g., interface between a radio access network (RAN) and a core network).

In some implementations, the NG interface includes a software or hardware interface between 5G core network (5GC) 310 including, e.g., SMF (Session Management Function), AMF (Access and Mobility Management Function) and UPF (User Plane Function), and NG-RAN. In some implementations, NG interface is further divided into NG-C interface (e.g., N2 interface, NG control plane interface) and NG-U interface (e.g., N3 interface, NG user plane interface). NG-C interface is used to exchange control plane procedures (e.g., PDU Session management, UE Mobility management) between 5GC (5G core network) and NG-RAN. NG-U interface is used to transfer user plane data from 5GC to NG-RAN and from NG-RAN to 5GC.

In this patent document, the term “network” can be used to indicate both 5GC 310 and NG-RAN 320. In some implementations, the network can be implemented to support multicast/broadcast service (MBS) function. For example, both the 5GC 310 and NG-RAN 320 may support MBS function, and NG-RAN t320 hat supports MBS function can establish MRB (MBS radio bear) to transmit user data of MBS session to UE in a point to multipoint (PTM) mode.

After at least one UE has joined the MBS session or MBS service, if the corresponding NG-RAN 320 supports MBS function, the network may configure the MBS session (e.g., 336) and establish a shared N3 tunnel (e.g., 346) at the NG interface. The MBS session is common to all UEs joining the MBS session. The shared N3 tunnel (e.g., 346) is common to and shared by all UEs joining the MBS session, and is used to transmit the user data associated with this MBS session through 5GC shared MBS traffic delivery mode to all UEs.

At the same NG interface, after a UE has joined the MB S service (or MB S session), the network may configure a PDU (Protocol Data Unit) session including the relationship with the MBS session and may establish a UE-specific N3 tunnel (e.g., 342, 344) for the UE. Each UE joining the MBS session can use a dedicated PDU session (e.g., 332, 334). Here, the PDU session can be a new PDU session or an existing PDU session. This UE-specific N3 tunnel is a dedicated communication channel for each UE joining the MBS session, and is used to transmit, to the UE, the user data associated with the MBS session included in PDU session through 5GC individual MBS traffic delivery mode.

If the NG-RAN does not support MBS function, the network does not establish MBS session and shared N3 tunnel. Instead, the network only establishes PDU session and UE-specific N3 tunnel. In this patent document, the term “UE” can be used to indicate mobile devices than join MBS session.

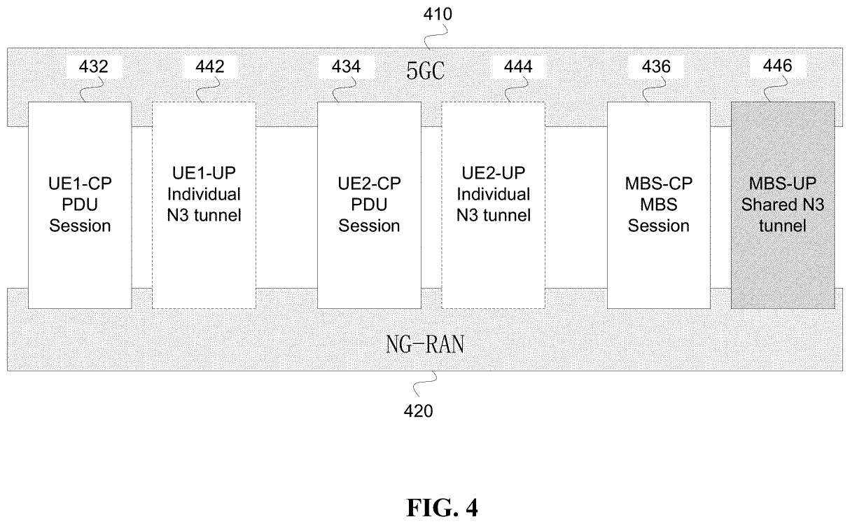

FIG. 4 depicts an example of MBS user data transmission at NG interface based on some implementations of the disclosed technology.

In case that NG interface has configured the shared N3 tunnel (e.g., 446), the MBS user data from 5GC 410 is sent to NG-RAN 420 through the shared N3 tunnel (e.g., 446) other than UE-specific N3 tunnel (e.g., 442, 444). For each UE joining the MBS session, its MBS user data of this MBS session is also transmitted through the shared N3 tunnel (e.g., 446) other than through its individual N3 tunnel (e.g., 442, 444). Therefore, although UE's individual N3 tunnel (e.g., 442, 444) is configured, the UE's MBS user data from 5GC 410 does not transmit through N3 tunnel (e.g., 442, 444). In this case, the UE's individual N3 tunnel may be referred to as “dummy N3 tunnel.”

Each UE's PDU session includes the relationship of the MBS session, each UE's PDU session configuration includes the MBS session configuration. In some implementations, at NG-C interface, the network configures MBS session and PDU session(s) for each UE. At NG-U interface, the network shall configure unique shared N3 tunnel for all UEs and may configure UE-specific individual N3 tunnel for each UE. The user data of both the MBS session and the PDU sessions for each UE is transmitted from 5GC to NG-RAN by the unique shared N3 tunnel.

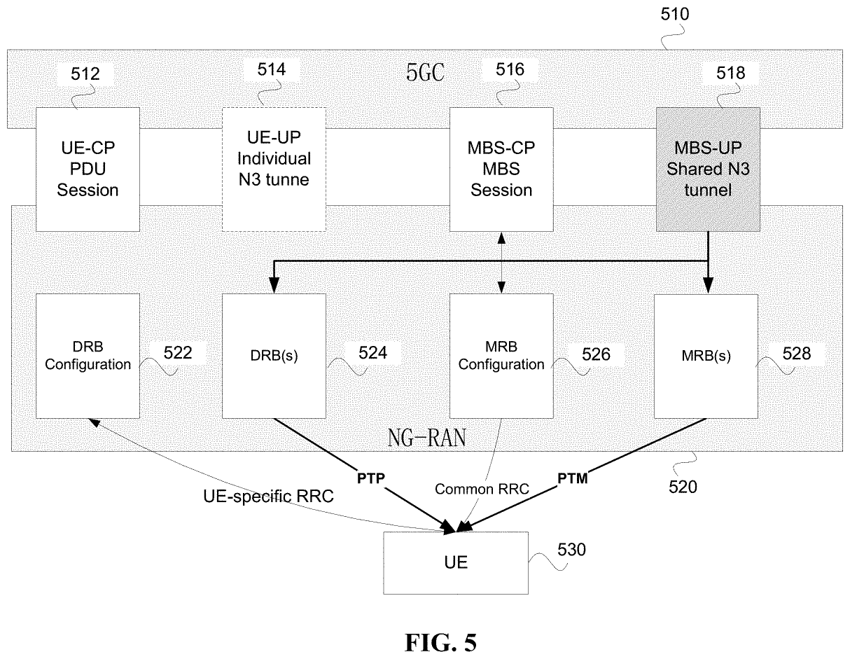

FIG. 5 depicts an example of radio bearer configuration at NG-RAN (next-generation radio access network) based on some implementations of the disclosed technology.

Upon completion of configuring an MBS session at NG interface, NG-RAN may configure one or more MRBs (MBS radio bears) for the MBS session. The MBS session can include one or more MBS QoS (quality of service) flows, and NG-RAN maps the one or more MBS QoS flows to one or more MRBs. The configuration information of this/these MRB(s) is common to all UEs, and the configuration information can be transmitted by broadcast signaling (e.g., SIB or MCCH) or by UE-specific RRC signaling separately to each UE. One MBS session can be mapped to one or more MRBs, so that the user data of this MBS session is transmitted to all UEs in a PTM (point to multipoint mode) mode.

Upon completion of configuring a UE-specific PDU session (e.g., 512) at NG interface, NG-RAN 520 may configure DRB (dedicated radio resource) for all UEs or some of the UEs. For a UE (e.g., 530), NG-RAN maps its own UE-specific PDU session (e.g., 512), which includes the relationship of the same MBS session, to one or more DRBs. In one example, different UEs may have the same mapping between PDU session and DRB. In another example, the mapping between PDU session and DRB (e.g., DRB number and DRB configuration parameters) may be different for different UEs. In one example, the mapping between PDU session and DRB may be the same as the mapping between MBS session and MRB. In another example, the mapping between PDU session and DRB may be different from the mapping between MBS session and MRB.

The user data of the MBS session, which is configured within PDU session 512 (i.e., MBS session configuration is included in the PDU session configuration) and is mapped to UE-specific DRB(s) 522, can be transmitted to each UE in a point-to-point (PTP) mode. When configured with UE-specific DRBs 524, UE can receive user data of the MBS session in PTP mode and/or PTM mode.

In some implementations, after the network configures an MBS session at NG interface between 5GC 510 and NG-RAN 520, the NG-RAN 520 configures one or more MRBs 528 for the MBS session. The MBS session includes one or more MBS QoS flows, and the NG-RAN 520 maps the one or more MBS QoS flows to one or more MRBs 528. The MRB configuration information 526 associated with the one or more MRB (s) is common to all UEs and can be transmitted by common RRC signaling to all UEs (e.g., 530). One MBS session can be mapped into one or more MRBs (e.g., 528), so that the user data of this MBS session is transmitted to all UEs in a PTM (point to multiple-point) mode.

In some implementations of the disclosed technology, the user data of the MBS session can be transmitted using a combination of the point-to-point (PTP) mode and/or the point-to-multipoint (PTM) mode. The network can switch between the PTP mode and the PTM mode during a transmission of the user data and can use the PTP mode and the PTM mode simultaneously. In some implementations of the disclosed technology, such mode switching features can be implemented by having the same QoS flow to DRB mapping in both the PTP mode and the PTM mode. For example, a mapping between a dedicated radio bearer (DRB) and a protocol data unit (PDU) session includes one or more MBS QoS flows, and a mapping between a multicast broadcast service radio bearer (MRB) and a multicast broadcast service (MBS) session includes one or more MBS QoS flows. In this case, the QoS flow to DRB and the QoS flow to MRB have the same mapping, thereby enabling such mode switching features.

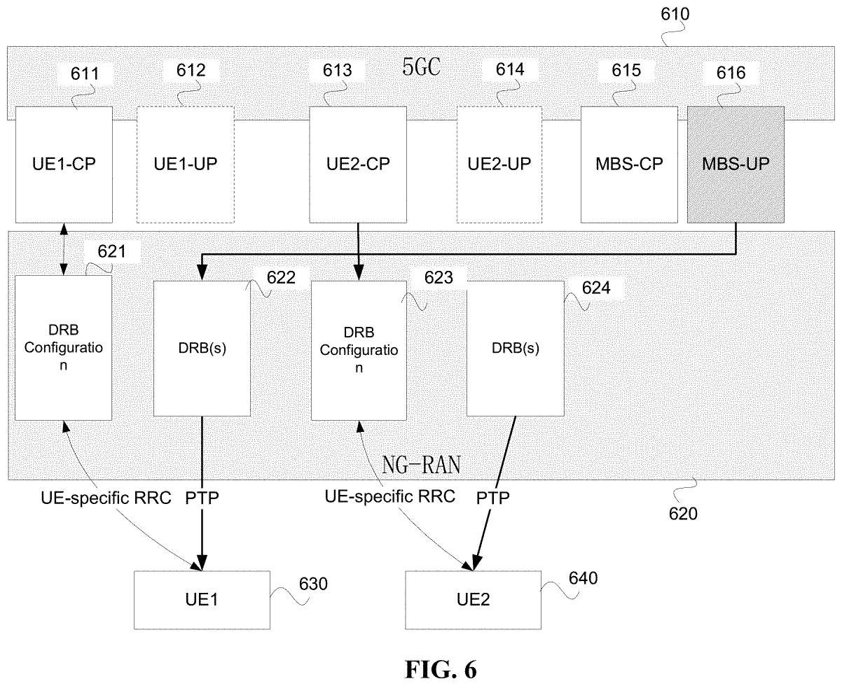

FIG. 6 depicts an example of a dedicated radio resource (DRB) configured without configuring multicast/broadcast service radio bearer (MRB) based on some implementations of the disclosed technology.

Upon completion of configuring the MBS session at NG interface, NG-RAN 620 can decide not to establish MRB for the MBS session for some reasons. For instance, NG-RAN 620 does not establish MRB for the MBS session if the number of UEs is below a threshold value that requires using a point-to-multipoint communication. In this case, NG-RAN 620 establishes DRBs (e.g., 622, 624) for all UEs (e.g., 630, 640) to receive user data of the MBS session in PTP mode.

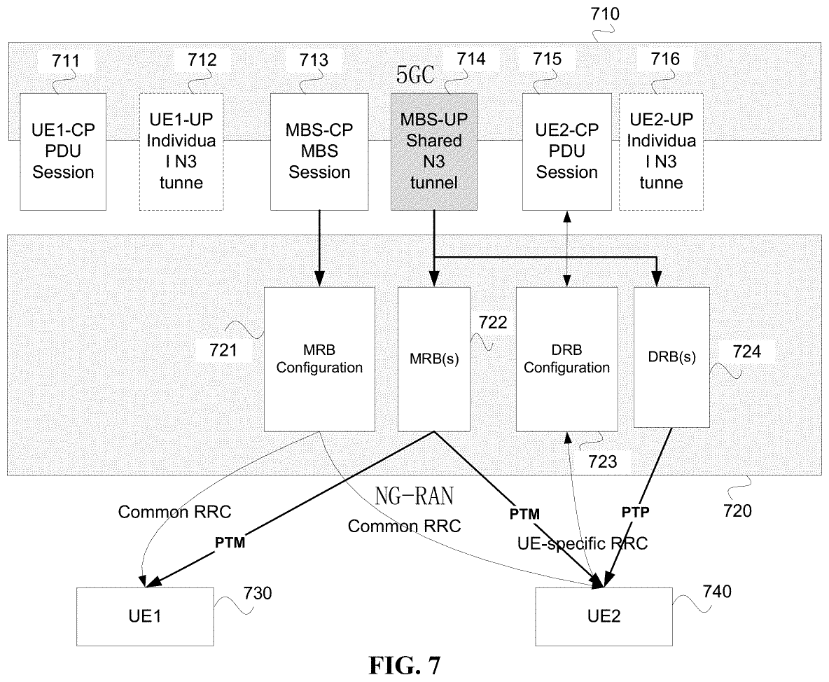

FIG. 7 depicts an example of a dedicated radio resource (DRB) configured for some of mobile devices (e.g., UEs) in the network based on some implementations of the disclosed technology.

In some implementations, upon completion of configuring the MBS session (e.g., 713) and the PDU session (e.g., 711, 715), including the relationship with the MBS session, for each UE 730, 740 at NG interface, NG-RAN 720 can decide to establish both the MRB(s) (e.g., 722) and DRB(s) (e.g., 724) for the MBS session configured in the PDU session for all or some of UEs. In some implementations, upon completion of configuring the MBS session 713 and the PDU session 711, 715, including the relationship with MBS session, for each UE 730, 740 at NG interface, NG-RAN 720 can decide to establish DRB(s) 723 for the MBS session for all of the UEs without establishing MRB(s) for the MBS session.

In some implementations, for a UE joining an MBS session, if both the DRB and MRB are configured for the MBS session, the UE can decide to receive (1) the DRB only, (2) the MRB only, or (2) both the DRB and MRB. As shown in FIG. 7, if a first UE (UE1) 730 is not configured with the DRB, the first UE can receive use data associated with the MBS session in PTM mode. If a second UE (UE2) 740 is configured with the DBR 724, then the second UE 740 can receive user data associated with the MBS session in (1) PTP mode only, (2) PTM mode only, or (3) both PTP mode and PTM mode simultaneously.

Referring to FIG. 6, NG-RAN may count the number of UEs in one area (e.g., one cell). If the number of UEs is below a certain threshold, the NG-RAN decides not to establish MRB for this MBS session while establishing DRB for each UE, all UEs (e.g., UE1 and UE2) camped into the area (e.g., the cell) receive the MB session in PTP mode. Referring to FIG. 7, NG-RAN may count the number of UE in one area (e.g., one cell). If the number of UEs exceeds a certain threshold, the NG-RAN may decide to establish MRB for this MBS session. The NG-RAN may decide not to establish DRB for UE1 (e.g., UE1 is located at the center of the area) while establishing DRB for UE2 (e.g., UE2 is located at the board of the area). Thus, the UE1 receives the MBS session in PTM mode and the UE2 can select either mode or can receive the MBS session using both PTP and PTM modes.

In some implementations, the network may switch the transmission or reception mode of the user data from the PTP mode to the PTM mode. For example, UE (e.g., UE2) that is configured with both DRB and MRB can transmit a notification to NG-RAN that the UE does not need to use the PTP mode to receive MBS session. In some implementation, UE can decide whether to transmit such a notification based on the quality of signal transmission. In one example, when the signal transmission quality of the user data of MBS session in PTM mode exceeds a predetermined threshold value, DRB is not used to transmit the user data of the MBS session, and UE only uses PTM mode to receive the MBS session. Although the DRB is configured for the UE, the DRB is not used to transmit user data to the UE. In another example, when UE uses PTM mode only to receive the MBS session, the DRB is released. In some implementations, the NG-RAN transmits an RRC reconfiguration message to UE to indicate that the DRBs mapped to the MBS session are released.

In some implementations, the network may switch the transmission or reception mode of the user data from the PTM mode to the PTP mode. For example, UE (e.g., UE2) that is configured with both DRB and MRB but is not using DRB to receive user data can transmit a notification to NG-RAN that the UE needs to use the PTP mode to receive MBS session. In one example, when the signal transmission quality of the user data of MBS session in PTM mode is below a predetermined threshold value, NG-RAN resumes to transmit the user data of the MBS session on the DRB, and the UE (e.g., UE2) can receive the MBS session in PTP mode again.

In some implementations, MBS user data that has been transmitted in PTM mode can be retransmitted in PTP mode. For example, UE (e.g., UE2) that is configured with both DRB and MRB and is receiving MBS user data in PTM mode can transmit a request to NG-RAN that some of MBS user data packets be retransmitted by using DRB. In this case, the NG-RAN retransmit these MBS user data packets on DRB to UE in PTP mode.

In a certain area of the network (e.g., a cell), the user data of the MBS session is transmitted on the MRB to all UEs in PTM mode. For UE that is configured with both DRB and MRB, when the signal transmission quality of the user data of MBS session in PTM mode exceeds a predetermined threshold value, the UE can transmit a request to the network that the MBS user data be transmitted in PTM mode without transmitting in PTP mode. When there is a need to supplement the MBS user data packets the UE has received, the UE can transmit a request to NG-RAN that at least part of the MBS user data packets be retransmitted in PTP mode. For UE that is configured with both DRB and MRB, when the signal transmission quality of the user data of MBS session in PTM mode is below a predetermined threshold value, the UE can transmit a request to the network that the MBS user data be transmitted in PTP mode.

In some implementations, the network can use the same QoS flow to DRB mapping and MRB mapping. The mapping from PDU session to DRB may or may not be the same for different UEs, and may or may not be the same as the mapping from MBS session to MRB. In one example, the NG-RAN implemented based on some embodiments of the disclosed technology may configure the same mapping from PDU session to DRB for all UEs, and can configure the same mapping for PDU session to DRB mapping and MBS session to MRB mapping.

In some implementations, both the user data of the MBS session and the user data of the PDU session may be received from the shared N3 tunnel. Therefore, the same mapping may allow the packet data convergence protocol (PDCP) sequence number (PDCP SN) of each DRB and PDCP SN of each MRB to be aligned.

The same mapping applied to DRB mapping and MRB mapping may improve flexibility and reliability of the signal reception of the mobile devices (e.g., UE) associated with the multicast/broadcast service (MBS) session. In one example, a mobile device configured with both DRB and MRB (e.g., UE2 in FIG. 7) may receive MBS user data using both PTP mode and PTM mode simultaneously and combine the data packets from the DRB and MRB based on aligned PDCP SN.

A mobile device configured with both DRB and MRB may receive MBS user data in PTM at a certain point in time. In some embodiments of the disclosed technology, upon determination that one or more PDCP packets may not correctly received on MRB, the mobile device can send to NG-RAN a message including the PDCP SN indication, and in response the NG-RAN can retransmit PDCP packets conveyed on DRB to the UE in PTP mode.

In receiving MBS user data, the same mapping applied to DRB mapping and MRB mapping may enable switching between PTP mode and PTM mode. As such, the reception mode can be switched from PTP mode to PTM mode such that MBS user data that is being received in PTP mode can be received in PTM mode, and the reception mode can be switched from PTM mode to PTP mode such that MBS user data that is being received in PTM mode can be received in PTP mode. MBS user data that is received in different modes (e.g., PTM mode and PTM mode) can be incorporated based on the PDCP SN.

After the network configures the MBS session and PDU session, including the MBS session relationship discussed above, for each UE at NG interface, the NG-RAN can establish (1) MRB for all UEs and DRB for at least one of UEs, or (2) DRB for each UEs without establishing MRB.

NG-RAN may transmit MBS user data to UE joining the MBS session using a combination of the point-to-point mode and/or the point-to-multipoint mode. For UE configured with both DRB and MRB, NG-RAN can transmit MBS user data in the following ways. First, NG-RAN may stop transmitting MBS user data conveyed on DRB so that the UE receives the MBS user data conveyed on MRB using PTM mode. Second, NG-RAN may stop transmitting MBS user data conveyed on MRB so that the UE receives MBS user data conveyed on DRB using PTP mode. Third, NG-RAN may transmit MBS user data conveyed on both DRB and MRB so that UE can receive MBS user data conveyed on DRB using PTP mode and/or MBS user data conveyed on MRB using PTM mode.

As such, the UE joining the MBS session and configured with both DRB and MRB can receive MBS user data by using (1) both PTP mode and PTM mode simultaneously, (2) by using PTP mode only, or (3) by using PTM mode only.

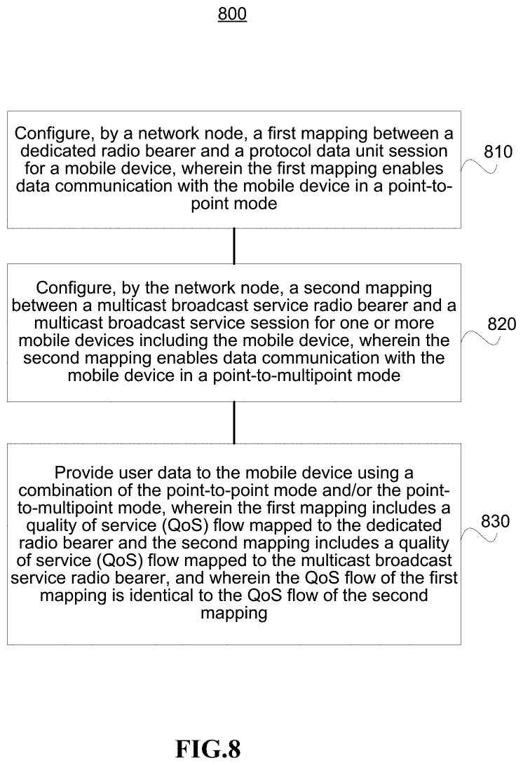

FIG. 8 depicts an example method 800 for wireless communication based on some example embodiments of the disclosed technology. At 810, the method includes configuring, by a network node (e.g., NG-RAN or 5GC), a first mapping between a dedicated radio bearer (e.g., DRB) and a protocol data unit session (e.g., PDU session) for a mobile device (e.g., UE). Here, the first mapping enables data communication with the mobile device in a point-to-point mode. At 820, the method includes configuring, by the network node, a second mapping between a multicast broadcast service radio bearer (e.g., MRB) and a multicast broadcast service session (e.g., MBS session) for one or more mobile devices including the mobile device, wherein the second mapping enables data communication with the mobile device in a point-to-multipoint mode. At 830, the method includes providing user data to the mobile device using a combination of the point-to-point mode and/or the point-to-multipoint mode. In some implementations, the first mapping includes a quality of service (QoS) flow mapped to the dedicated radio bearer and the second mapping includes a quality of service (QoS) flow mapped to the multicast broadcast service radio bearer. In some implementations, the QoS flow of the first mapping is identical to the QoS flow of the second mapping.

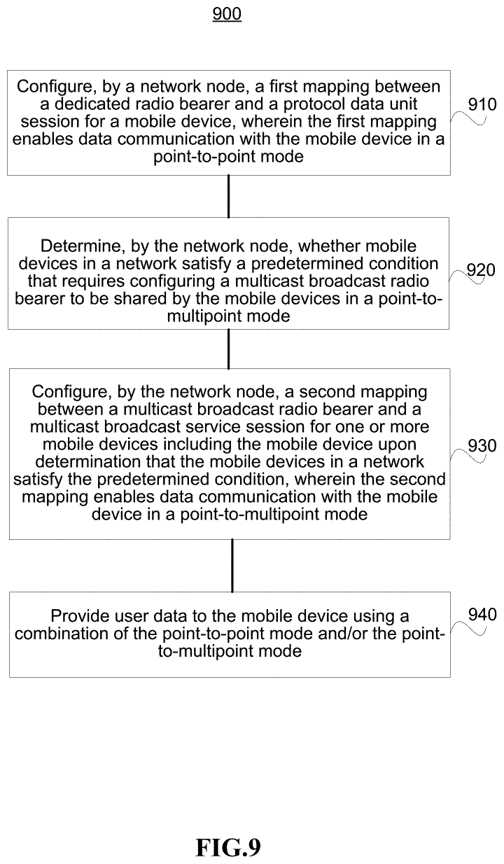

FIG. 9 depicts another example of a process for wireless communication based on some example embodiments of the disclosed technology. At 910, the method includes configuring, by a network node (e.g., NG-RAN or 5GC), a first mapping between a dedicated radio bearer (e.g., DRB) and a protocol data unit session (e.g., PDU session) for a mobile device (e.g., UE), wherein the first mapping enables data communication with the mobile device in a point-to-point mode. At 920, the method includes determining, by the network node, whether mobile devices in a network satisfy a predetermined condition that requires configuring a multicast broadcast radio bearer (e.g., MRB) to be shared by the mobile devices in a point-to-multipoint mode. At 930, the method includes configuring, by the network node, a second mapping between a multicast broadcast radio bearer (e.g., MRB) and a multicast broadcast service session (e.g., MBS session) for one or more mobile devices including the mobile device upon determination that the mobile devices in a network satisfy the predetermined condition, wherein the second mapping enables data communication with the mobile device in a point-to-multipoint mode. At 940, the method includes providing user data to the mobile device using a combination of the point-to-point mode and/or the point-to-multipoint mode.

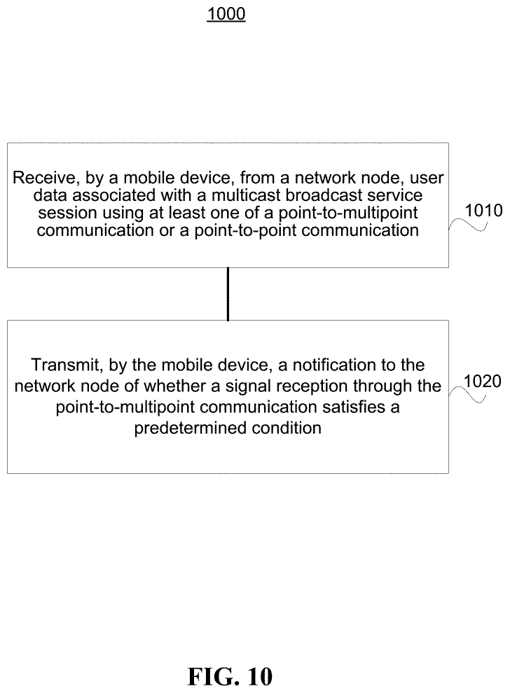

FIG. 10 depicts another example of a process for wireless communication based on some example embodiments of the disclosed technology. At 1010, the method includes receiving, by a mobile device (e.g., UE), from a network node (e.g., NG-RAN), user data associated with a multicast broadcast service session (e.g., MBS session) using at least one of a point-to-multipoint communication or a point-to-point communication. At 1020, the method includes transmitting, by the mobile device, a notification to the network node of whether a signal reception through the point-to-multipoint communication satisfies a predetermined condition.

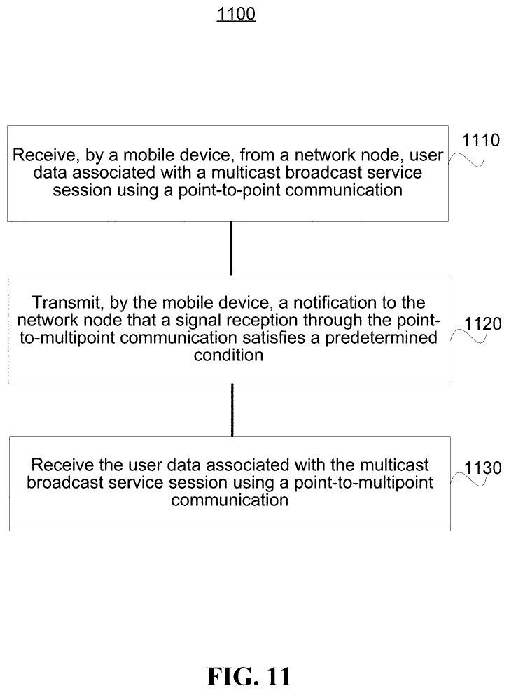

FIG. 11 depicts another example of a process for wireless communication based on some example embodiments of the disclosed technology. At 1110, the method includes receiving, by a mobile device (e.g., UE), from a network node (e.g., NG-RAN), user data associated with a multicast broadcast service session (e.g., MBS session) using a point-to-point communication. At 1120, the method includes transmitting, by the mobile device, a notification to the network node that a signal reception through the point-to-multipoint communication satisfies a predetermined condition. At 1130, the method includes receiving the user data associated with the multicast broadcast service session using a point-to-multipoint communication.

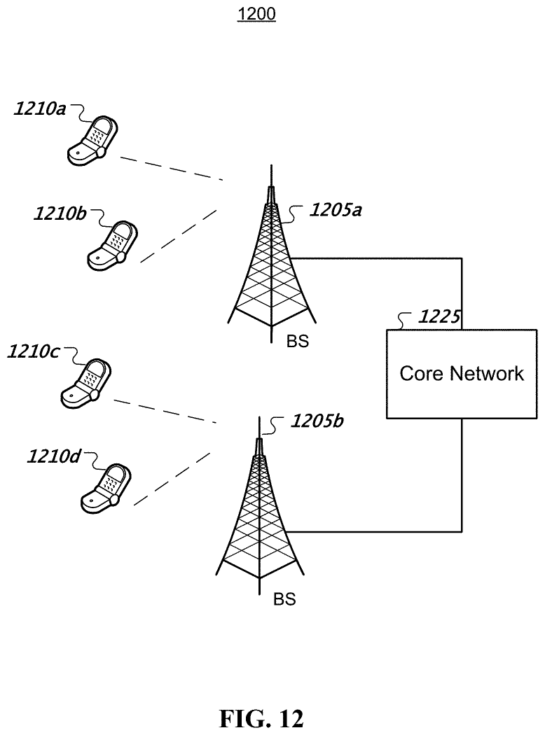

FIG. 12 shows an example of a wireless communication system 1200 where techniques in accordance with one or more embodiments of the present technology can be applied. A wireless communication system 1200 can include one or more base stations (BSs) 1205a, 1205b, one or more wireless devices 1210a, 1210b, 1210c, 1210d, and a core network 1225. A base station 1205a, 1205b can provide wireless service to wireless devices 1210a, 1210b, 1210c and 1210d in one or more wireless sectors. In some implementations, a base station 1205a, 1205b includes directional antennas to produce two or more directional beams to provide wireless coverage in different sectors.

The core network 1225 can communicate with one or more base stations 1205a, 1205b. The core network 1225 provides connectivity with other wireless communication systems and wired communication systems. The core network may include one or more service subscription databases to store information related to the subscribed wireless devices 1210a, 1210b, 1210c, and 1210d. A first base station 1205a can provide wireless service based on a first radio access technology, whereas a second base station 1205b can provide wireless service based on a second radio access technology. The base stations 1205a and 1205b may be co-located or may be separately installed in the field according to the deployment scenario. The wireless devices 1210a, 1210b, 1210c, and 1210d can support multiple different radio access technologies. The techniques and embodiments described in the present document may be implemented by the base stations of wireless devices described in the present document.

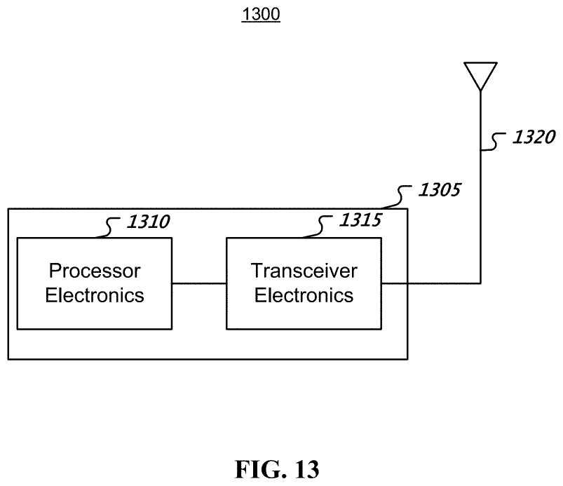

FIG. 13 is a block diagram representation of a portion of a radio station in accordance with one or more embodiments of the present technology can be applied. A radio 1305 such as a base station or a wireless device (or UE) can include processor electronics 1310 such as a microprocessor that implements one or more of the wireless techniques presented in this document. The radio 1305 can include transceiver electronics 1315 to send and/or receive wireless signals over one or more communication interfaces such as antenna 1320. The radio 1305 can include other communication interfaces for transmitting and receiving data. Radio 1305 can include one or more memories (not explicitly shown) configured to store information such as data and/or instructions. In some implementations, the processor electronics 1310 can include at least a portion of the transceiver electronics 1315. In some embodiments, at least some of the disclosed techniques, modules or functions are implemented using the radio 1305. In some embodiments, the radio 1305 may be configured to perform the methods described in this document. The network node described in the present application may be implemented using the above-described radio station or by using a hardware platform that includes a combination of one or more processors, one or more network interface hardware and one or more memories for storing processor-executable code or data.

It will be appreciated that the present document discloses techniques that can be embodied in various embodiments to establish and manage multicast sessions in various scenarios. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the Examples above and throughout this document. As used in the clauses below and in the claims, a wireless terminal may be user equipment, mobile station, or any other wireless terminal including fixed nodes such as base stations. A network node includes a base station including a next generation Node B (gNB), enhanced Node B (eNB), or any other device that performs as a base station. A resource range may refer to a range of time-frequency resources or blocks.

Clause 1. A method of data communication, comprising: configuring, by a network node (e.g., NG-RAN or 5GC), a first mapping between a dedicated radio bearer (e.g., DRB) and a protocol data unit session (e.g., PDU session) for a mobile device (e.g., UE), wherein the first mapping enables data communication with the mobile device in a point-to-point mode, configuring, by the network node, a second mapping between a multicast broadcast service radio bearer (e.g., MRB) and a multicast broadcast service session (e.g., MBS session) for one or more mobile devices including the mobile device, wherein the second mapping enables data communication with the mobile device in a point-to-multipoint mode, and providing user data to the mobile device using a combination of the point-to-point mode and/or the point-to-multipoint mode, wherein the first mapping includes a quality of service (QoS) flow mapped to the dedicated radio bearer and the second mapping includes a quality of service (QoS) flow mapped to the multicast broadcast service radio bearer, and wherein the QoS flow of the first mapping is identical to the QoS flow of the second mapping.

Clause 2. The method of clause 1, wherein the using the combination of the point-to-point mode and/or the point-to-multipoint mode comprises transmitting the user data to the mobile device in the point-to-point mode, transmitting the user data to the mobile device in the point-to-multipoint mode, and switching between the point-to-point mode and the point-to-multipoint mode.

Clause 3. The method of clause 2, further comprising retransmitting, in the point-to-point mode, the user data transmitted in the point-to-multipoint mode.

Clause 4. The method of clause 1, wherein the multicast broadcast service session includes one or more quality of service (QoS) flows mapped to one or more multicast broadcast radio bearers.

Clause 5. The method of clause 1, wherein the first mapping between the dedicated radio bearer and the protocol data unit session for a mobile device applies to all of the one or more mobile devices including the mobile device.

Clause 6. The method of clause 1, wherein user data associated with the protocol data unit session and user data associated with the multicast broadcast service session are transmitted through a shared tunnel such that packet data convergence protocol (PDCP) sequence numbers associated with the protocol data unit session and the multicast broadcast service session are aligned.

Clause 7. The method of clause 1, wherein the providing the user data to the mobile device using a combination of the point-to-point mode and/or the point-to-multipoint mode includes transmitting the user data in the point-to-point mode and the point-to-multipoint mode simultaneously.

Clause 8. A method of data communication, comprising configuring, by a network node (e.g., NG-RAN or 5GC), a first mapping between a dedicated radio bearer (e.g., DRB) and a protocol data unit session (e.g., PDU session) for a mobile device (e.g., UE), wherein the first mapping enables data communication with the mobile device in a point-to-point mode, determining, by the network node, whether mobile devices in a network satisfy a predetermined condition that requires configuring a multicast broadcast radio bearer (e.g., MRB) to be shared by the mobile devices in a point-to-multipoint mode, configuring, by the network node, a second mapping between a multicast broadcast radio bearer (e.g., MRB) and a multicast broadcast service session (e.g., MBS session) for one or more mobile devices including the mobile device upon determination that the mobile devices in a network satisfy the predetermined condition, wherein the second mapping enables data communication with the mobile device in a point-to-multipoint mode, and providing user data to the mobile device using a combination of the point-to-point mode and/or the point-to-multipoint mode.

Clause 9. The method of clause 8, wherein the predetermined condition is associated with at least one of a comparison between a total number of mobile devices in a network area and a predetermined threshold value, and a location of the mobile device in the network area relative to a center of the network area.

Clause 10. The method of clause 8, further comprising transmitting the user data from the network node to the mobile devices in the point-to-point mode using the configured dedicated radio bearer without configuring the multicast broadcast radio bearer upon determination that the mobile devices in the network fail to satisfy the predetermined condition, and switching the mode in which the user data is transmitted from the point-to-point mode to the point-to-multipoint mode in case that the multicast broadcast radio bearer is configured upon determination that the mobile devices in the network satisfy the predetermined condition.

Clause 11. The method of clause 8, wherein the first mapping includes a quality of service (QoS) flow mapped to the dedicated radio bearer and the second mapping includes a quality of service (QoS) flow mapped to the multicast broadcast service radio bearer, and wherein the QoS flow of the first mapping is identical to the QoS flow of the second mapping.

Clause 12. A method of data communication, comprising receiving, by a mobile device (e.g., UE), from a network node (e.g., NG-RAN), user data associated with a multicast broadcast service session (e.g., MBS session) using at least one of a point-to-multipoint communication or a point-to-point communication, and transmitting, by the mobile device, a notification to the network node of whether a signal reception through the point-to-multipoint communication satisfies a predetermined condition.

Clause 13. The method of clause 12, wherein the point-to-point communication is based on a first mapping between a dedicated radio bearer and a protocol data unit session for the mobile device, and the point-to-multipoint communication is based on a second mapping between a multicast broadcast radio bearer and a multicast broadcast service session for one or more mobile devices including the mobile device.

Clause 14. The method of clause 12, wherein the signal reception through the point-to-multipoint communication satisfies the predetermined condition upon a determination that a quality of a signal reception through the point-to-multipoint communication is superior to a quality of a signal reception through the point-to-point communication.

Clause 15. The method of clause 12, wherein the signal reception through the point-to-multipoint to-multipoint communication fails to satisfy the predetermined condition upon a determination that a quality of a signal reception through the point-to-multipoint communication is inferior to a quality of a signal reception through the point-to-point communication.

Clause 16. The method of clause 12, further comprising switching between the point-to-multipoint communication and the point-to-point communication based on the notification in receiving the user data associated with the multicast broadcast service session.

Clause 17. The method of clause 16, wherein the switching between the point-to-multipoint communication and the point-to-point communication includes switching from the point-to-point communication to the point-to-multipoint communication upon a determination that a quality of a signal reception through the point-to-multipoint communication is superior to a quality of a signal reception through the point-to-point communication.

Clause 18. The method of clause 16, wherein the switching between the point-to-multipoint communication and the point-to-point communication includes switching from the point-to-multipoint communication to the point-to-point communication upon a determination that a quality of a signal reception through the point-to-multipoint communication is inferior to a quality of a signal reception through the point-to-point communication.

Clause 19. The method of clause 12, wherein the receiving the user data using at least one of the point-to-multipoint communication or the point-to-point communication includes receiving the user data in the point-to-point mode and the point-to-multipoint mode simultaneously.

Clause 20. The method of clause 19, further comprising combining a data packet of the user data received in the point-to-point mode and another data packet of the user data received the point-to-multipoint mode.

Clause 21. A method of data communication, comprising receiving, by a mobile device (e.g., UE), from a network node (e.g., NG-RAN), user data associated with a multicast broadcast service session (e.g., MBS session) using a point-to-point communication, and transmitting, by the mobile device, a notification to the network node that a signal reception through the point-to-multipoint communication satisfies a predetermined condition, and receiving the user data associated with the multicast broadcast service session using a point-to-multipoint communication.

Clause 22. The method of clause 21, wherein the receiving of the user data associated with the multicast broadcast service session using the point-to-multipoint communication is performed without using the point-to-point communication.

Clause 23. The method of clause 21, wherein the predetermined condition is satisfied upon a determination that a quality of a signal reception through the point-to-multipoint communication is superior to a quality of a signal reception through the point-to-point communication.

Clause 24. The method of clause 21, wherein the receiving of the user data associated with the multicast broadcast service session using the point-to-multipoint communication is performed using both the point-to-multipoint communication and the point-to-point communication.

Clause 25. The method of clause 21, wherein a dedicated radio bearer is configured to transmit the user data associated with the multicast broadcast service session using the point-to-point communication.

Clause 26. The method of clause 21, further comprising receiving a message indicating that the dedicated radio bearer mapped to the multicast broadcast service session is released.

Clause 27. The method of clause 21, wherein a multicast broadcast radio bearer is configured to transmit the user data associated with the multicast broadcast service session using the point-to-multipoint communication.

Clause 28. The method of clause 21, further comprising transmitting a notification, by the mobile device, to the network node that the point-to-multipoint communication fails to satisfy the predetermined condition, and resuming the receiving of the user data associated with the multicast broadcast service session using the point-to-point communication.

Clause 29. An apparatus for wireless communication, comprising a memory and a processor, wherein the processor reads code from the memory and implements a method recited in any of clauses 1 to 28.

Clause 30. A computer readable program storage medium having code stored thereon, the code, when executed by a processor, causing the processor to implement a method recited in any of clauses 1 to 28.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of data communication, comprising:
configuring, by a network node, a first mapping between a dedicated radio bearer and a protocol data unit session for a mobile device, wherein the first mapping enables data communication with the mobile device in a point-to-point mode;
configuring, by the network node, a second mapping between a multicast broadcast service radio bearer and a multicast broadcast service session for one or more mobile devices including the mobile device, wherein the second mapping enables data communication with the mobile device in a point-to-multipoint mode; and
providing user data to the mobile device using at least one of the point-to-point mode or the point-to-multipoint mode,
wherein the first mapping includes a quality of service (QoS) flow mapped to the dedicated radio bearer and the second mapping includes a quality of service (QoS) flow mapped to the multicast broadcast service radio bearer, and
wherein the QoS flow of the first mapping is identical to the QoS flow of the second mapping.

2. The method of claim 1, wherein the using the at least one of the point-to-point mode or the point-to-multipoint mode comprises:
transmitting the user data to the mobile device in the point-to-point mode;
transmitting the user data to the mobile device in the point-to-multipoint mode; and
switching between the point-to-point mode and the point-to-multipoint mode.

3. The method of claim 1, wherein the multicast broadcast service session includes one or more quality of service (QoS) flows mapped to one or more multicast broadcast radio bearers.

4. The method of claim 1, wherein the first mapping between the dedicated radio bearer and the protocol data unit session for a mobile device applies to all of the one or more mobile devices including the mobile device.

5. The method of claim 1, wherein user data associated with the protocol data unit session and user data associated with the multicast broadcast service session are transmitted through a shared tunnel such that packet data convergence protocol (PDCP) sequence numbers associated with the protocol data unit session and the multicast broadcast service session are aligned.

6. The method of claim 1, wherein the providing the user data to the mobile device using a combination of the point-to-point mode and/or the point-to-multipoint mode includes transmitting the user data in the point-to-point mode and the point-to-multipoint mode simultaneously.

7. The method of claim 1, further comprising:
determining, by the network node, whether mobile devices in a network satisfy a predetermined condition that requires configuring a multicast broadcast radio bearer to be shared by the mobile devices in a point-to-multipoint mode,
wherein the second mapping between the multicast broadcast service radio bearer and the multicast broadcast service session for the one or more mobile devices including the mobile device is configured upon determination that the mobile devices in a network satisfy the predetermined condition.

8. The method of claim 7, wherein the predetermined condition is associated with at least one of:
a comparison between a total number of mobile devices in a network area and a predetermined threshold value; or
a location of the mobile device in the network area relative to a center of the network area.

9. A method of data communication, comprising:
receiving, by a mobile device, from a network node, user data associated with a multicast broadcast service session using at least one of a point-to-multipoint communication or a point-to-point communication; and
transmitting, by the mobile device, a notification to the network node of whether a signal reception through the point-to-multipoint communication satisfies a predetermined condition.

10. The method of claim 9, wherein the point-to-point communication is based on a first mapping between a dedicated radio bearer and a protocol data unit session for the mobile device, and the point-to-multipoint communication is based on a second mapping between a multicast broadcast radio bearer and a multicast broadcast service session for one or more mobile devices including the mobile device.

11. The method of claim 9, wherein the signal reception through the point-to-multipoint communication satisfies the predetermined condition upon a determination that a quality of a signal reception through the point-to-multipoint communication is superior to a quality of a signal reception through the point-to-point communication.

12. The method of claim 9, wherein the signal reception through the point-to-multipoint communication fails to satisfy the predetermined condition upon a determination that a quality of a signal reception through the point-to-multipoint communication is inferior to a quality of a signal reception through the point-to-point communication.

13. The method of claim 9, further comprising switching between the point-to-multipoint communication and the point-to-point communication based on the notification in receiving the user data associated with the multicast broadcast service session.

14. The method of claim 9, wherein the receiving the user data using at least one of the point-to-multipoint communication or the point-to-point communication includes receiving the user data in a point-to-point mode and a point-to-multipoint mode simultaneously.

15. A method of data communication, comprising:
receiving, by a mobile device, from a network node, user data associated with a multicast broadcast service session using a point-to-point communication;
transmitting, by the mobile device, a notification to the network node that a signal reception through a point-to-multipoint communication satisfies a predetermined condition; and
receiving the user data associated with the multicast broadcast service session using a point-to-multipoint communication.

16. The method of claim 15, wherein the receiving of the user data associated with the multicast broadcast service session using the point-to-multipoint communication is performed without using the point-to-point communication or using both the point-to-multipoint communication and the point-to-point communication.

17. The method of claim 15, wherein the predetermined condition is satisfied upon a determination that a quality of a signal reception through the point-to-multipoint communication is superior to a quality of a signal reception through the point-to-point communication.

18. The method of claim 15, wherein a dedicated radio bearer is configured to transmit the user data associated with the multicast broadcast service session using the point-to-point communication.

19. The method of claim 15, wherein a multicast broadcast radio bearer is configured to transmit the user data associated with the multicast broadcast service session using the point-to-multipoint communication.

20. The method of claim 15, further comprising:
transmitting a notification, by the mobile device, to the network node that the point-to-multipoint communication fails to satisfy the predetermined condition; and
resuming the receiving of the user data associated with the multicast broadcast service session using the point-to-point communication.
